(19) United States
(12) Patent Application Publication
(10) Pub. No.: US 2006/0156349 A1
(43) Pub. Date: Jul. 13, 2006

(54) Digital video player accessory

(76) Inventors: Herschel Naghi, Los Angeles, CA (US); Craig S. Erickson, Stevenson Ranch, CA (US)

Correspondence Address: CHRISTIE, PARKER & HALE, LLP, PO BOX 7068, PASADENA, CA, 91109-7068, US

(21) Appl. No.: 11/325,883

(22) Filed: Jan. 4, 2006

Related U.S. Application Data
(60) Provisional application No. 60/641,379, filed on Jan. 5, 2005.

(51) Int. Cl. H04N 7/173; H04N 7/18; H04N 5/44

(52) U.S. Cl. 725/75; 348/725; 725/100; 725/131

(57) ABSTRACT

A portable digital video player accessory for use with a portable digital audio player is provided. The portable digital video player accessory includes a display screen for displaying a video. The video is generated using the data stored in a memory and/or a hard disk drive of the portable digital audio player. The portable digital video player accessory further includes a processing core adapted to control the display on the display screen. The portable digital video player accessory also includes an interface port for interfacing the portable digital video player accessory with an interface port of the portable digital audio player. The portable digital video player accessory also includes a power source for supplying power to the display screen and the processing core.

### CROSS-REFERENCE TO RELATED APPLICATION

This application claims priority to and the benefit of U.S. Provisional Patent Application No. 60/641,379 filed Jan. 5, 2005, the entire content of which is incorporated by reference herein.

### FIELD OF THE INVENTION

The present invention relates to a video/graphics display system, and more particularly, to a digital video player accessory that can be used together with a digital audio player or a digital audio device (e.g., MP3 player) to realize a multimedia center for providing multimedia contents to the users.

### BACKGROUND

A number of portable digital audio players, digital audio devices or digital music players for playing music using compressed music/audio files are available. By far the most popular compressed music/audio format today is MP3, and iPod® (including the iPod Nano and iPod Mini) marketed by Apple Computer is the most popular and widely used MP3 player in the market today. APPLE® and IPOD® are registered trademarks of Apple Computer, Inc., a California corporation.

It is often desirable to provide digital video (e.g., a movie) and/or animated graphics as well as music to provide multimedia experience to the users. Conventional portable digital audio players and MP3 players, including Apple iPod, are limited in that they can typically play music but not display movie or video. While portable multimedia devices or systems for providing audio and video entertainment using compressed video and audio files stored therein are also available on the market, they tend to be significantly higher in price than the portable digital audio players. Also, existing owners of portable digital audio players may not wish to purchase an additional portable digital video player or a portable multimedia system.

Therefore, it is desirable to provide a portable system or accessory capable of working with off-the-shelf portable MP3 players and/or other digital audio players to provide video display as well as audio.

### SUMMARY

In one exemplary embodiment of the present invention, a portable digital video player accessory for use with a portable digital audio player is provided. The portable digital video player accessory has a memory and/or a hard disk drive for storing data, and includes a display screen for displaying a video thereon, the video being generated using the data stored in the memory and/or the hard disk drive of the portable digital audio player. The portable digital video player accessory also includes a processing core adapted to control the display on the display screen, an interface port for interfacing the portable digital video player accessory with an interface port of the portable digital audio player, and a power source for supplying power to the display screen and the processing core.

In another exemplary embodiment of the present invention, a method of displaying a video using a compressed video file is provided. The method includes interfacing a portable digital audio player to a portable digital video player accessory, the portable digital audio player having a memory and/or a hard disk drive capable of storing the compressed video file, transferring the compressed video file from the memory and/or the hard disk drive of the portable digital audio player to the portable digital video player accessory, decompressing the compressed video file, and displaying the video corresponding to the decompressed video file on a display screen of the portable digital video player accessory.

In yet another exemplary embodiment of the present invention, a digital media system is provided. The digital media system includes a portable digital audio player having a memory and/or a hard disk drive for storing data, and a portable digital video player accessory for displaying video using the data stored in the memory and/or the hard disk drive. The digital video player accessory includes a display screen for displaying a video thereon, the video being generated using the data stored in the memory and/or the hard disk drive of the portable digital audio player, a processing core adapted to control the display on the display screen, an interface port for interfacing the portable digital video player accessory with an interface port of the portable digital audio player, and a power source for supplying power to the display screen and the processing core.

These and other aspects of the present invention will be more readily comprehended in view of the discussion herein and accompanying drawings.

### BRIEF DESCRIPTION OF THE DRAWINGS

FIG. 1A is a block diagram of a portable digital video player accessory according to one exemplary embodiment of the present invention;

FIG. 1B is a block diagram of a portable digital video player accessory having a video camera module, according to another exemplary embodiment of the present invention;

FIG. 2 is a block diagram of the portable digital video player accessory of FIG. 1 being used with an Apple/HP® iPod device;

FIG. 3 is a block diagram of the portable digital video player accessory of FIG. 1 being used with a portable MP3 player;

FIG. 4 is a perspective view of a portable digital video player accessory according to an exemplary embodiment of the present invention, coupled to a portable digital audio player;

FIG. 5 is a perspective view of a portable digital video player accessory according to another exemplary embodiment of the present invention, coupled to a portable digital audio player;

FIG. 6 is a side view of a portable digital video player accessory according to another exemplary embodiment of the present invention, coupled to a portable digital audio player;

FIG. 7 is a perspective view of the portable digital video player accessory of FIG. 6;

FIG. 8 is a perspective view of a portable digital video player accessory according to another exemplary embodiment of the present invention;

FIG. 9 is a perspective view of a portable digital video player accessory according to another exemplary embodiment of the present invention.

### DETAILED DESCRIPTION

In one embodiment of the present invention, a portable digital video player accessory for use with a portable digital audio player is provided. The portable digital video player accessory includes a display screen for displaying a video thereon, and a processing core used for controlling the display on the display screen. The video is stored in a memory and/or a hard disk drive in the portable digital audio player as a compressed video in a compressed format, and the processing core is used to decompress the compressed video to generate the video that can be displayed. The portable digital video player accessory also includes a serial interface port (such as a USB) for interfacing with a corresponding serial port of the portable digital audio player to receive the compressed data therefrom. The portable digital video player accessory also includes a power source for supplying power to the display screen and the processing core.

The portable digital audio player may be a portable MP3 player, or an iPod available from Apple Computer, Inc.

In another embodiment of the present invention, a method of displaying video and providing audio using a portable digital audio player is provided. Video and audio are stored as compressed video and compressed audio in a memory and/or a hard disk drive of the portable digital audio player. The compressed video and/or the compressed audio may be read from the portable digital audio player and decompressed and output as the video for display on a display screen of the portable video player accessory and as an audio output. The audio output (e.g., audible voice and/or music) may be provided by the portable digital audio player and/or by the portable digital video player accessory.

In exemplary embodiments according to the present invention, a portable digital video player accessory includes a display screen or a display device for displaying video and graphics using compressed files stored in a portable digital audio player, such as an MP3 player. The display screen may include a liquid crystal display (LCD) or any other suitable display device known to those skilled in the art, or a suitable display device that will be developed in the future. The portable digital video player accessory, therefore, turns a portable digital audio player such as an iPod into a multimedia center with which a user can listen to music and/or watch a movie.

The portable digital video player accessory should have a power source, such as a rechargeable battery. By way of example, the power to the portable digital video player accessory can be provided by a lithium ion rechargeable battery. In addition, the portable digital video player accessory includes electronic circuitry (e.g., on an integrated circuit chip) or a processing core for controlling the display and/or outputting of sound as well as for interfacing with the portable digital audio player (and/or a hard disk drive thereof).

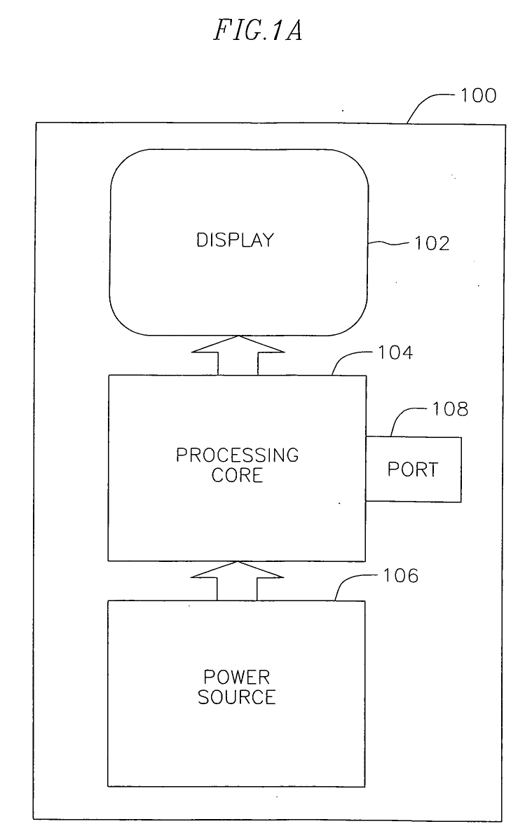

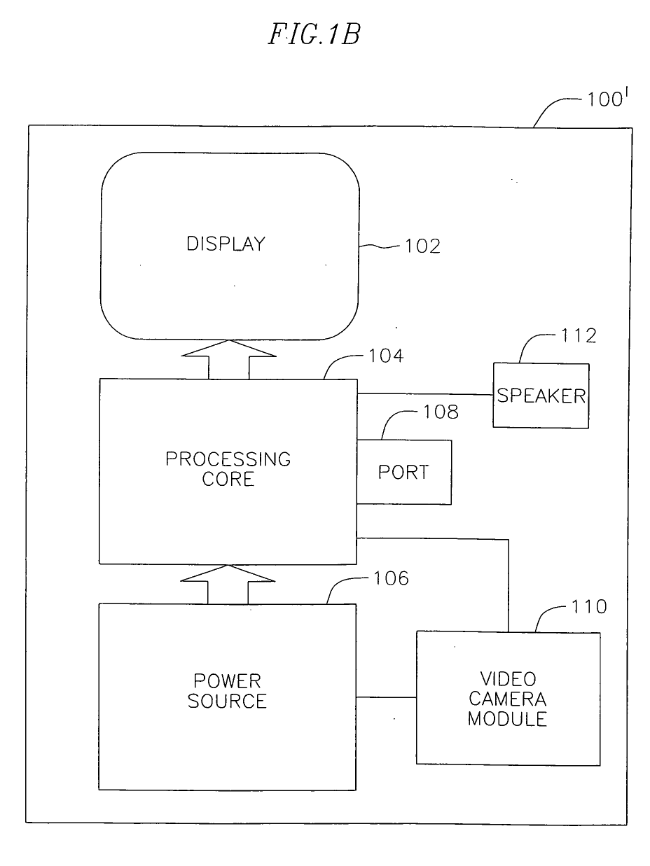

As can be seen in FIG. 1A, a portable digital video player accessory 100 includes a display (e.g., display screen) 102, a processing core 104, a power source 106 and a communication port or an interface port (e.g., a serial bus port) 108. The display 102 may be a color LCD or any other suitable display device/screen. By way of example, the display 102 may be 3.5 inches to 3.125 inches in size, and may have a resolution of 320×240, 400×300, or the like. Further, the communication port 108 may be a Universal Serial Bus On-The-Go (USB OTG) port.

The processing core 104 is a control/communication device that can include any suitable integrated circuit chip such as a SPCA536VA chip available from Sunplus Technology. SUNPLUS™ is a trademark of Sunplus Technology Co., Ltd., a Taiwan corporation. The processing core 104 should include one or more MPEG-4 compression and decompression modules for performing compression and decompression of MPEG-4 video and audio. The processing core 104 should also include an LCD driver to control display of the video on the display 102. In addition, the processing core 104 should include a sound amplifier/driver to generate and control audio output of the portable digital audio player coupled to the portable digital video player accessory 100. The portable digital video player accessory 100 may include one or more speakers (e.g., see FIG. 1B) for generating audio output using compressed audio files received from a portable digital audio player. A headset may be coupled to the portable digital audio player and/or the portable digital video player accessory for private listening of music and/or audio associated with a movie.

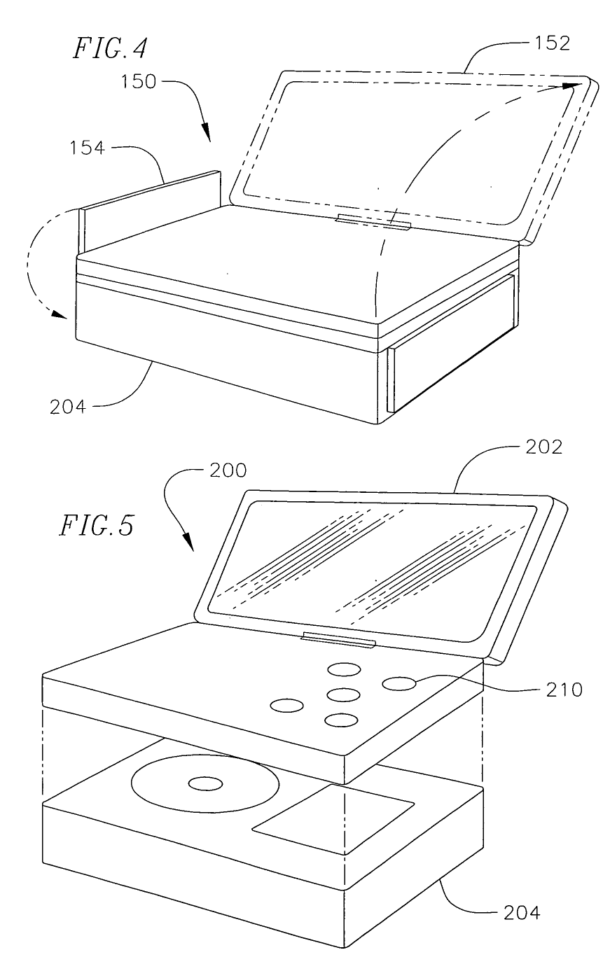

By way of example, using video compression (e.g., MPEG-4 compression), about 125 movies having an average length of 90 minutes can be recorded into a 20G hard disk drive of an iPod. Different lengths of compressed video files may be recorded in a hard disk drive and/or a memory (e.g., NAND flash memory) of other iPods or MP3 players. The portable digital video player accessory should also have a number of control buttons, switches, and/or the like mounted thereon (e.g., shown in FIG. 5) that can be used as an on/off switch and/or to implement player controls such as play/pause, stop, fast forward (FF), fast reverse (FR) as well as volume controls, and/or the like.

The iPod can be formatted with PC or Macintosh® (MAC®), and other portable digital audio players or portable MP3 players may similarly be formatted with PC or MAC. Therefore, the movie or video files can be placed upon the iPod or other portable MP3-type digital audio player hard disk drives and/or by either PC or Macintosh computer systems. Hence, the processing core 104 an IDE interface, and support UDisk and FAT32 protocols to handle FAT32 file system in the case of PC format iPod, and HFS+ protocol for a MAC format iPod. MACINTOSH® and MAC® are registered trademarks of Apple Computer, Inc., a California corporation.

The processing core 104 should also support NTSC, PAL, and/or HDTV video formats. The processing core 104 may also be able to support any suitable formats known to those skilled in the art. The processing core 104 may also have the capability to interface with a digital video camera input. Further, as shown in FIG. 1B for example, a portable digital video player accessory 100′ in another exemplary embodiment can be used (e.g., together with a portable digital audio player as a storage medium) as a video camera. The portable digital video player accessory can also include conversion software to translate the different movie file formats to an MPEG encrypted format, which may be a standard format or a format specific to the portable digital video player accessory. The portable digital video play accessory may also include a hard disk drive and/or a memory of its own for storing video data, audio data and/or other data.

Each of the portable digital video player accessories can have a unique numeric ID, and the files for each unit can be encrypted differently, such that files made for a certain digital video player accessory can be played only using that particular portable digital video player accessory.

The power source 106, by way of example, can include a lithium ion rechargeable battery or any other suitable battery and/or other power source. The communication port 108 is a device interface that can be used for communications between the portable digital video player accessory 100 or 100′ and the portable digital audio player. For example, the communication port 108 can be used to communicate with an iPod operating system (OS) and/or the hard disk drive to get the files to stream off or to read the files and/or data for decompression and/or other processing.

As can be seen in FIG. 1B, the portable digital video player accessory 100′ can have a video camera function with a video camera module 110. Using the video camera function, the portable digital video player accessory 100′ can capture images and compress them into MPEG-4 format and/or any other suitable compressed video format, and provide the compressed video files to the portable digital audio player to be stored in the hard disk drive thereof. The processing core 104 should provide the digital camera interface, and also video compression capabilities using its MPEG-4 compression module(s) and/or other video compression module(s). The power to the video camera module 110 is provided by the power source (e.g., battery) 106. The portable digital video player accessory 100′ also includes one or more speakers 112 for providing an audio output using compressed audio files from a portable digital audio player, such as an iPod. The portable digital video player accessory 100 or 100′ may also include an input port for receiving video signals from an external video camera.

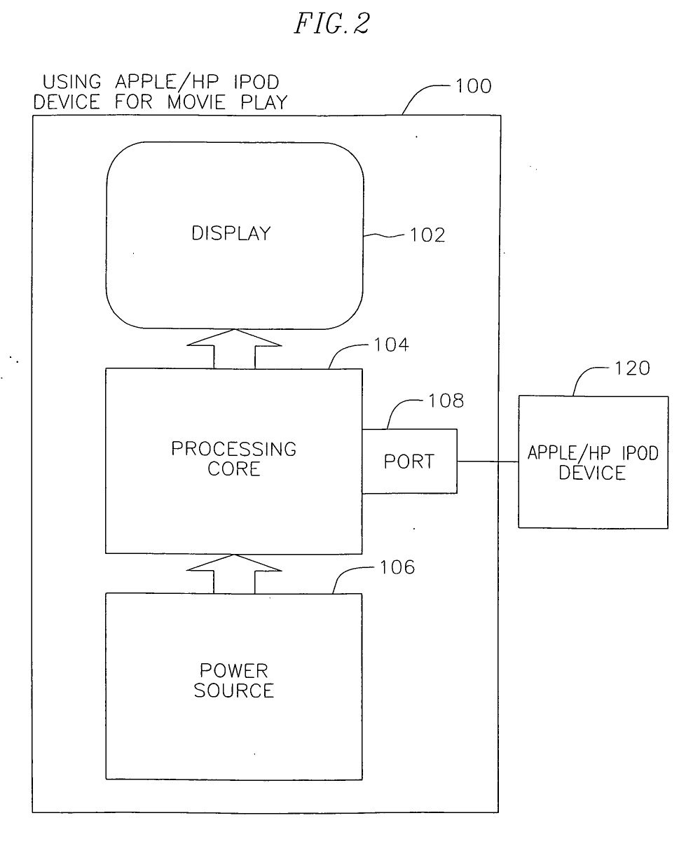

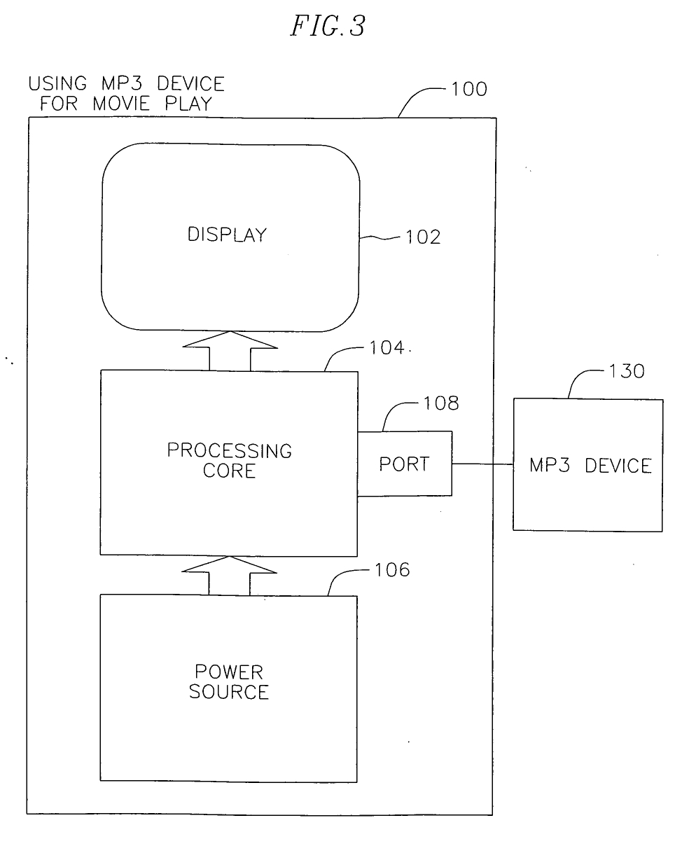

As shown in FIG. 2, the portable digital video player accessory 100 (also the portable digital video player accessory 100′) can be used together with an iPod device 120 available from/through Apple Computer and/or Hewlett Packard® (HP®). HEWLETT PACKARD® and HP® are registered trademarks of Hewlett-Packard Company, a California corporation. The communication port 108 is used to communicate with the iPod OS and hard disk drive to obtain video and/or audio content stored in the iPod's hard disk drive. Similarly, as shown in FIG. 3, the portable digital video player accessory 100 (also the portable digital video player accessory 100′) can be used together with any other suitable MP3 device 130. The communication port 108 is used to communicate with the operating system residing in the MP3 device 130 and its hard disk drive to obtain video and/or audio content stored therein.

A portable digital video player accessory 150 of FIG. 4 is shown as having been assembled together with a portable digital audio player 204, which may be an iPod or any other suitable MP3 player. A display screen 152 can be opened (or lifted) up to be in an open position (e.g., as shown by an arrow in FIG. 4) or be folded down to be in a closed position. The display screen 152 in its open position (i.e., fully lifted position) is shown as a phantom line in FIG. 4. The portable digital video player accessory 150 also includes a flap portion 154, which is rotatable about a pivot between the flap portion 154 and the main body of the digital video player accessory 150. The flap portion 154 has mounted thereon one or more connectors for electrically connecting the portable digital video player accessory 150 with the portable digital audio player 204. This way, the portable digital video player accessory can easily be mounted on or over the portable digital audio player, then the flap portion 154 is rotated outwardly (e.g., as shown by an arrow in FIG. 4) to interface with the portable digital audio player 204.

A portable digital video player accessory 200 of FIG. 5 has a display screen 202 that can be opened up or folded down. The portable digital video player accessory 200 can be mounted or docked using a top/down motion on or over the portable digital audio player 204. The display screen 202 as well as other display screens described herein can include an LCD or any other suitable display device. Further, the display screen 202 may, for example, have a screen size of 3.5 inches to 3.125 inches, and may be capable of displaying 320×240 pixels, 400×300 pixels, and/or the like. Control elements (e.g., buttons and/or switches) 210 are mounted on the portable digital video player accessory 200, and are used as an on/off switch and/or to implement player controls such as play/pause, stop, fast forward (FF), fast reverse (FR) as well as volume controls, and/or the like.

A portable digital video player accessory 250 of FIG. 6 has a display screen 252 that can be opened up or folded down. The portable digital video player accessory 250 has a cutout 205 (a slot or an opening) on at least one of its sides, such that the portable digital audio player 204 can be slid in to be substantially under the portable digital video player accessory 250. The portable digital video player accessory 250 does not necessarily have to touch the portable digital audio player on all sides, and there can be a space or gap between the portable digital video player accessory 200 and the portable digital audio player 204. However, the connector(s) of the portable digital video player accessory should make electrical connections with the corresponding connector(s) of the portable digital audio device 204, such that a communication port (e.g., such as the communication port 108 of FIGS. 1A-3) can be used to communicate with the portable digital audio player 204.

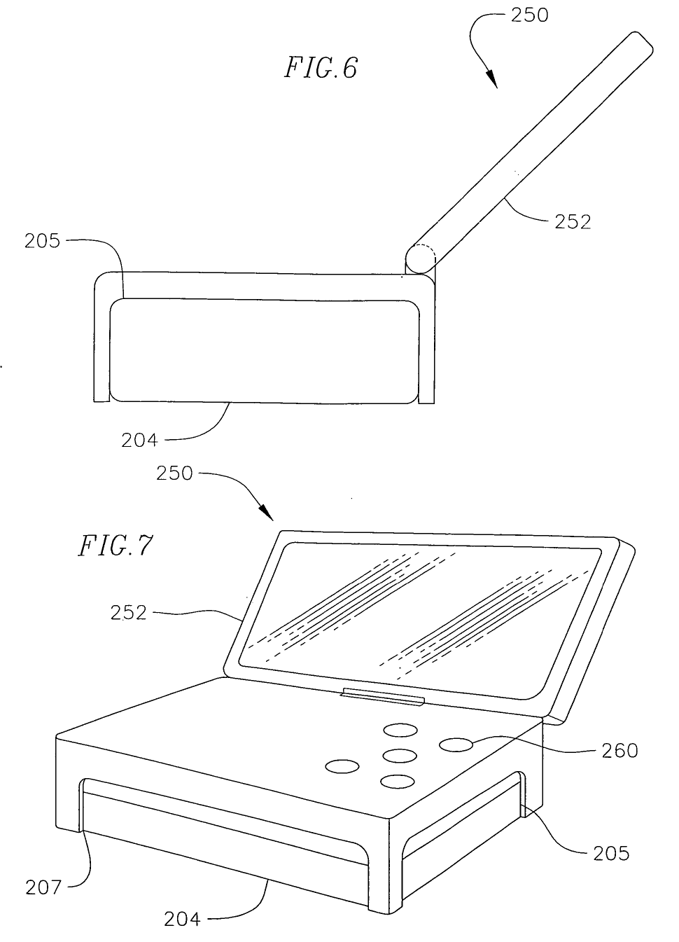

As can be seen in FIG. 7, the portable digital video player accessory 250 also has a cutout 207 (a slot or an opening) in its front wall such that at least a portion of the portable digital audio player 204 is visible from the front of the portable digital video player accessory 250. In other embodiments, such cutout of the front wall may not be present. FIG. 7 also illustrates control elements 260 of the portable digital video player accessory 250.

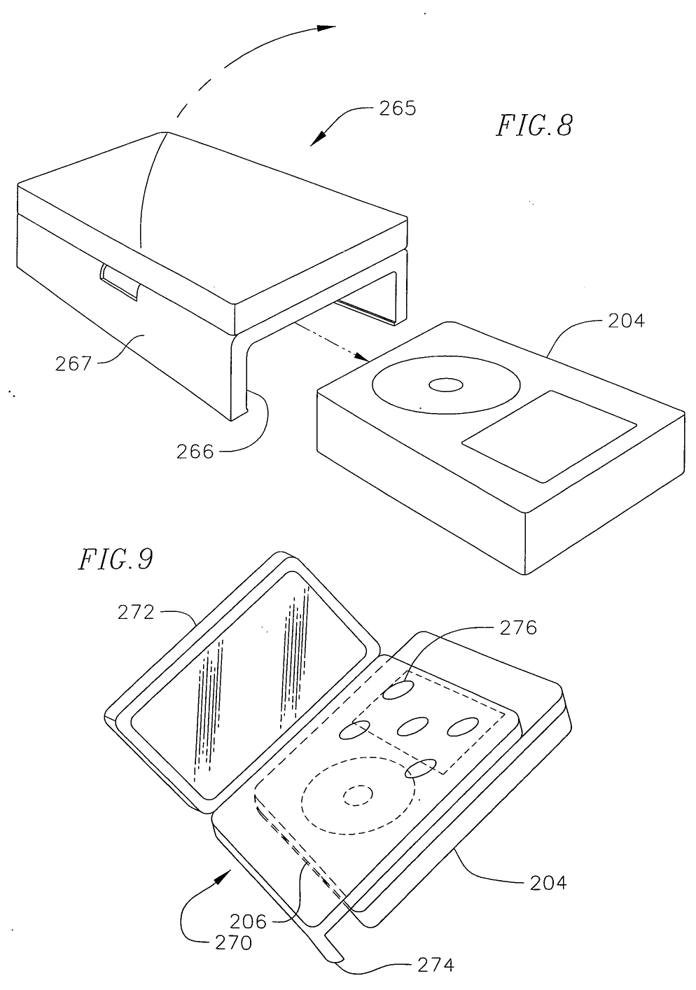

A portable digital video player accessory 265 according to another exemplary embodiment of the present invention is slid onto a portable digital audio player 204 as shown in FIG. 8. The portable digital video player accessory 265 has a cutout 266 on its side wall such that the portable digital audio player 204 can be slid in to fit under the portable digital video player accessory 265. The portable digital video player accessory 265 does not have a cutout on its front wall 267 as shown in FIG. 8. However, the portable digital video player accessory can have a cutout on the front wall in other embodiments.

A portable digital video player accessory 270 in another exemplary embodiment according to the present invention as shown in FIG. 9 has a display screen 272, which can be opened up or folded down, and control elements 276. It can be seen in FIG. 9 that the portable digital video player accessory 270 has only one side wall 274 such that the portable digital audio player 204 can be slid under the portable digital video player accessory 270 for assembly with relative ease. The side wall 274 should have a connector mounted on its inner surface so as to interface with an interface connector 206 of the digital audio player 204.

The interface between the portable digital video player accessory 272 and the portable digital audio player 204 can include an USB OTG, IDE, or any other suitable interface known to those skilled in the art. Incidentally, when the portable digital audio player 204 is an iPod, the portable digital video player accessory 272, as well as other portable digital video player accessories described herein, can be said to be docked to the bottom of the iPod because the interface connector 206 is located at the bottom of the iPod.

While certain exemplary embodiments have been described above in detail and shown in the accompanying drawings, it is to be understood that such embodiments are merely illustrative of and not restrictive of the broad invention. It will thus be recognized that various modifications may be made to the illustrated and other embodiments of the invention described above, without departing from the broad inventive scope thereof. In view of the above it will be understood that the invention is not limited to the particular embodiments or arrangements disclosed, but is rather intended to cover any changes, adaptations or modifications which are within the spirit and scope of the present invention as can be determined, for example, by the appended claims and their equivalents.

1. A portable digital video player accessory for use with a portable digital audio player having a memory and/or a hard disk drive for storing data, the portable digital video player accessory comprising:
a display screen for displaying a video thereon, the video being generated using the data stored in the memory and/or the hard disk drive of the portable digital audio player;
a processing core adapted to control the display on the display screen;
an interface port for interfacing the portable digital video player accessory with an interface port of the portable digital audio player; and
a power source for supplying power to the display screen and the processing core independently of the portable digital audio player.

2. The portable digital video player accessory of claim 1, wherein the portable digital video player accessory includes a flap portion and a main body, the flap portion being rotatable about a pivot between the flap portion and the main body of the portable digital video player accessory.

3. The portable digital video player accessory of claim 2, wherein the flap portion has mounted thereon at least one connector for electrically coupling the portable digital video player accessory to the portable digital audio player.

4. The portable digital video player accessory of claim 1, wherein the display screen is adapted to be opened up or folded down.

5. The portable digital video player accessory of claim 1, wherein the portable digital video player accessory is adapted to be mounted over the portable digital audio player.

6. The portable digital video player accessory of claim 1, wherein the portable digital video player accessory has an opening on at least one of its side walls, the opening being adapted to receive the portable digital audio player such that the portable digital audio player is substantially under the portable digital video player accessory.

7. The portable digital video player accessory of claim 6, wherein at least one of the side walls has a connector mounted on its inner surface for interfacing the portable digital video player accessory with an interface connector of the portable digital audio player.

8. The portable digital video player accessory of claim 1, wherein the portable digital video player accessory and the portable digital audio player form at least one of USB OTG interface or IDE interface.

9. The portable digital video player accessory of claim 1, wherein the portable digital video player accessory includes a number of control buttons and switches, adapted to control the portable digital video player accessory.

10. The portable digital video player accessory of claim 1, wherein the portable digital video player accessory includes conversion software to convert different movie data formats into MPEG encrypted format.

11. The portable digital video player accessory of claim 1, wherein the portable digital video player accessory has a unique numeric ID, such that encrypted files corresponding to a certain portable digital video player accessory can be played only using that particular portable digital video player accessory.

12. The portable digital video player accessory of claim 1, wherein the processing core is adapted to support at least one of UDisk, FAT32, and/or HFS+ protocols.

13. The portable digital video player accessory of claim 1, wherein the processing core is adapted to support NTSC, PAL and/or HDTV video formats.

14. The portable digital video player accessory of claim 1, wherein the processing core is adapted to interface with a digital video camera input.

15. The portable digital video player accessory of claim 1, wherein the processing core includes an LCD driver.

16. The portable digital video player accessory of claim 1, wherein the processing core includes one or more MPEG-4 compression and decompression modules.

17. A method of displaying a video using a compressed video file, the method comprising:
interfacing a portable digital audio player to a portable digital video player accessory, the portable digital audio player having a memory and/or a hard disk drive capable of storing the compressed video file;
transferring the compressed video file from the memory and/or the hard disk drive of the portable digital audio player to the portable digital video player accessory;
decompressing the compressed video file; and
displaying the video corresponding to the decompressed video file on a display screen of the portable digital video player accessory.

18. The method of claim 17, wherein the interfacing the portable digital audio player to the portable digital video player accessory comprises sliding the portable digital audio player under the portable digital video player accessory.

19. The method of claim 17, wherein the interfacing the portable digital audio player to the portable digital video play accessory comprises mounting the portable digital video play accessory on top of the portable digital audio player.

20. A digital media system comprising:
a portable digital audio player having a memory and/or a hard disk drive for storing data;
a portable digital video player accessory for displaying video using the data stored in the memory and/or the hard disk drive, the digital video player accessory comprising;
a display screen for displaying a video thereon, the video being generated using the data stored in the memory and/or the hard disk drive of the portable digital audio player;
a processing core adapted to control the display on the display screen;
an interface port for interfacing the portable digital video player accessory with an interface port of the portable digital audio player; and
a power source for supplying power to the display screen and the processing core independently of the portable digital audio player.

21. The digital media system of claim 20, wherein the portable digital audio player is an iPod.

22. The portable digital video player accessory of claim 1, further comprising a video camera module coupled to the processing core, wherein the video camera module is adapted to capture video to store the captured video in the memory and/or the hard disk drive of the portable digital audio player.
